(19) United States
(12) Patent Application Publication
(10) Pub. No.: US 2013/0317827 A1
(43) Pub. Date: Nov. 28, 2013

(54) VOICE CONTROL METHOD AND COMPUTER-IMPLEMENTED SYSTEM FOR DATA MANAGEMENT AND PROTECTION

(71) Applicants: Tsung-Chun Fu, Taoyuan County (TW); I-Ming Lo, Taipei City (TW)

(72) Inventors: Tsung-Chun Fu, Taoyuan County (TW); I-Ming Lo, Taipei City (TW)

(21) Appl. No.: 13/479,226

(22) Filed: May 23, 2012

(51) Int. Cl. G10L 17/00; G10L 11/00

(52) U.S. Cl. 704/273; 704/E11.001; 704/E17.004

(57) ABSTRACT

A computer-implemented system includes one or multiple application devices and a voice-controlled storage device. Multiple voice commands may be issued to multiple application devices simultaneously or separately, or to the same application device separately. The voice-controlled storage device is configured to perform content identification and voiceprint recognition on the voice commands. Therefore, each requestor may be allowed to operate the voice-controlled storage device in a corresponding operation mode according to respective authorization level.

### BACKGROUND

1. Technical Field

The present invention is related to a voice control method and a computer-implemented system, and more particularly, to a voice control method and a computer-implemented system for data management and protection.

2. Description of the Conventional Art

The computer architecture with a central processor governing a local data repository has been a standard in computing for decades. The architecture utilizes a central repository that is perceived as a slave to an associated processor. The processor governs the central repository by commanding storage and retrieval of information from the central storage. A myriad of electronic devices utilizing the familiar processor and memory structure have been developed, such as desktop/laptop/tablet personal computers (PCs), personal digital assistants (PDAs), smart phones, and the like. In addition to operational systems and software applications, portable electronic devices commonly store music, photos or movies for entertainment purpose. Data capacity, information sharing and data protection are key factors which influence user experience.

Cloud storage is a model of networked online storage where data is stored in virtualized pools of storage which are generally hosted by third parties. A high-capacity cloud-based wireless storage device may be accessed by multiple application devices via a wireless network. Cloud storage provides users with immediate access to a broad range of resources and applications hosted in the infrastructure of another organization via a web service interface, thus de-emphasizing the need for large device storage. Therefore, there is a need in the art for a method and a computer-implemented system capable of providing data management and protection between individual application devices and the cloud-based wireless storage device.

### SUMMARY

The present invention provides a computer-implemented system for data management and protection. The computer-implemented system includes an application software installed in a first application device for receiving and transmitting a first voice command and a storage device configured to receive the first voice command from the first application device via a network. The storage device includes a storage system having a voice recognition database for storing pre-recorded voiceprints and corresponding authorization levels to operate the voice-controlled storage device; processing unit configured to identify the first voice command and compare the first voice command with the pre-recorded voiceprints in the voice recognition database; and a control module configured to execute the first voice command according to a comparison result of the processing unit.

The present invention also provides a voice control method for a storage device The voice control method includes transmitting a first voice command from an application device to the storage device through a wireless path; identifying a content and a voiceprint of the first voice command; comparing the voiceprint with at least one pre-recorded voiceprint stored in the storage device for determining an authorization level; and executing the voice command according to the content of the voice command in a specific operation mode associated with the authorization level.

The present invention also provides a voice control method for a storage device. The voice control method includes transmitting a voice command from an application device to the storage device through a wireless path; determining if the voice command is firstly received from the application device; identifying a content and a voiceprint of the voice command when the voice command is firstly received from the application device; comparing the voiceprint with at least one pre-recorded voiceprint stored in the storage device for determining an authorization level; and executing the voice command according to the content of the voice command in a specific operation mode associated with the authorization level.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram illustrating a computer-implemented system for data management and protection according to the present invention.

FIGS. 2-4 are flowcharts illustrating the operation of a computer-implemented system according to the present invention.

### DETAILED DESCRIPTION

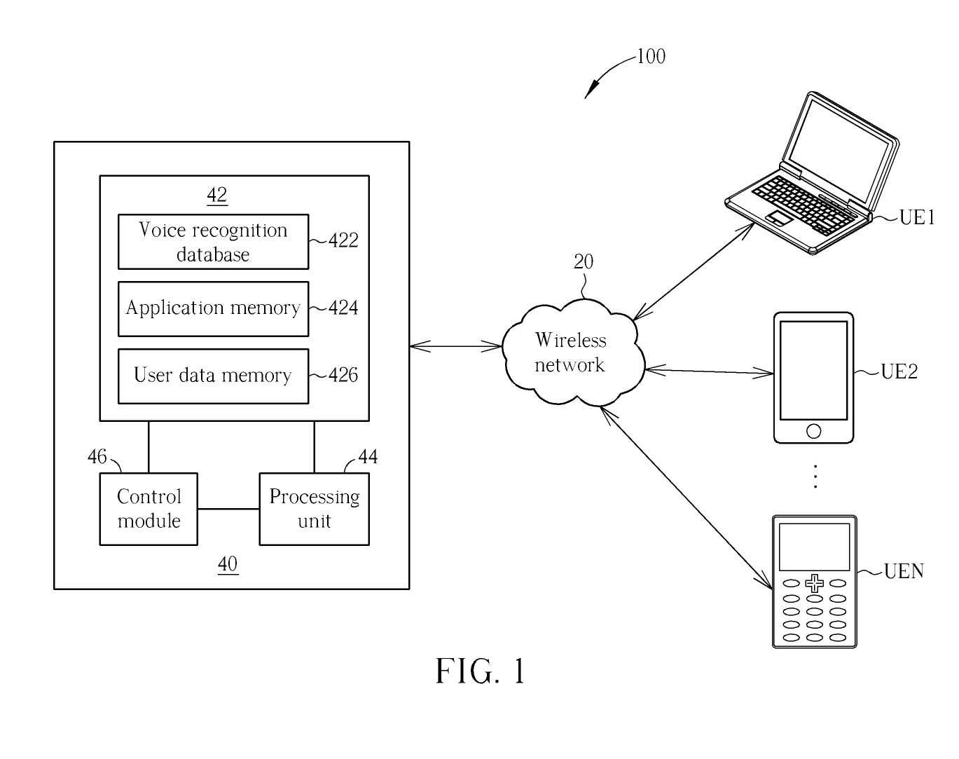

FIG. 1 is a functional diagram illustrating a computer-implemented system 100 for data management and protection according to a preferred embodiment of the present invention. The computer-implemented system 100 includes application devices UE1˜UEN and a voice-controlled storage device 40. The voice-controlled storage device 40 in the preferred embodiment of the present invention is a wireless storage device, which is able to be controlled wirelessly. The application devices UE1˜UEN may interact with the voice-controlled storage device 40 via a wireless network 20.

In the embodiment of the present invention, the wireless network 20 may be any wireless network known in the art, such as a wireless local area network (WLAN), a wireless metropolitan area network (WLAN) or a personal area network (PAN) and the like. For example, the wireless network 20 may be, but not limited to, a Bluetooth network or a Wi-Fi network.

In the embodiment of the present invention, one or more of the aforementioned application devices UE1˜UEN may be mobile electronic devices, while others may be wired electronic devices. Cloud application software may be installed in the application devices UE1˜UEN for intercommunicating with the voice-controlled storage device 40. As used herein, the phrase “application device” is used in its broadest sense to mean any electronic device capable of implementing one or more applications without being wired to any other device or power source. For example, a mobile application device may be, but not limited to, a cellular telephone, a smart phone, a wireless headset, a PDA, a laptop/tablet PC, an MP3 player, a mobile DVD player, or the like. A wired application device may be, but not limited to, a desktop computer or the like. Based on the disclosure provided herein, one of ordinary skill in the art will recognize a variety of application devices which may be used in relation to one or more embodiments of the present inventions.

The application devices UE1˜UEN may include a wireless network interface, an antenna, a processor, a memory system, and one or multiple input/output device (I/O device) (not shown in FIG. 1, but well-known to one of ordinary skill in the art) in each of the application devices UE1˜UEN. The I/O device includes an audio controller which supports an audio input device such as a microphone. Therefore, all application devices UE1˜UEN may be able to receive voice commands. Meanwhile, if the voice commands are received as analog signals, the application devices UE1˜UEN may further include an analog-to-digital converter for transforming the received voice commands into digital signals, which are then transmitted to the voice-controlled storage device. The application devices UE1˜UEN may further include I/O devices such as a graphical user interface controller or a user I/O controller. The graphical user interface controller supports a graphical user interface that may be integrated with the application devices UE1˜UEN. The user I/O controller supports a keyboard, a mouse or a pen interface device as are known in the art.

The voice-controlled storage device 40 includes a storage system 42, a processing unit 44 and a control module 46. The storage system 42 includes a voice recognition database 422, an application memory 424 and a user data memory 426. The voice recognition database 422 may include pre-recorded voiceprints of one or more users and corresponding authorization levels for operating the voice-controlled storage device 40. As used herein, the phrase “application memory” is used in its broadest sense to mean memory allocated to include software or firmware applications. As known in the art, such software and firmware applications include instructions executable by the processing unit 44 to perform one of a number of desired operations, such as identifying the content and the voiceprint of voice commands received from the application devices UE1˜UEN. As used herein, the phrase “user data memory” is used in its broadest sense to mean any memory allocated for data other than application data. Thus, for example, the user data memory 426 may store, but not limited to, audio files, video files, documents and other types of user data. The storage system 42 may be implemented with one or both of volatile and non-volatile memory media.

The processing unit 44 is configured to process the voice commands received from the application devices UE1˜UEN, including identifying the content and the voiceprint of voice commands, recognizing the voiceprint for determining an authorization level, and executing the voice commands. The control module 46 may be any circuitry or programmable controller that provides for access to and from the storage system 42.

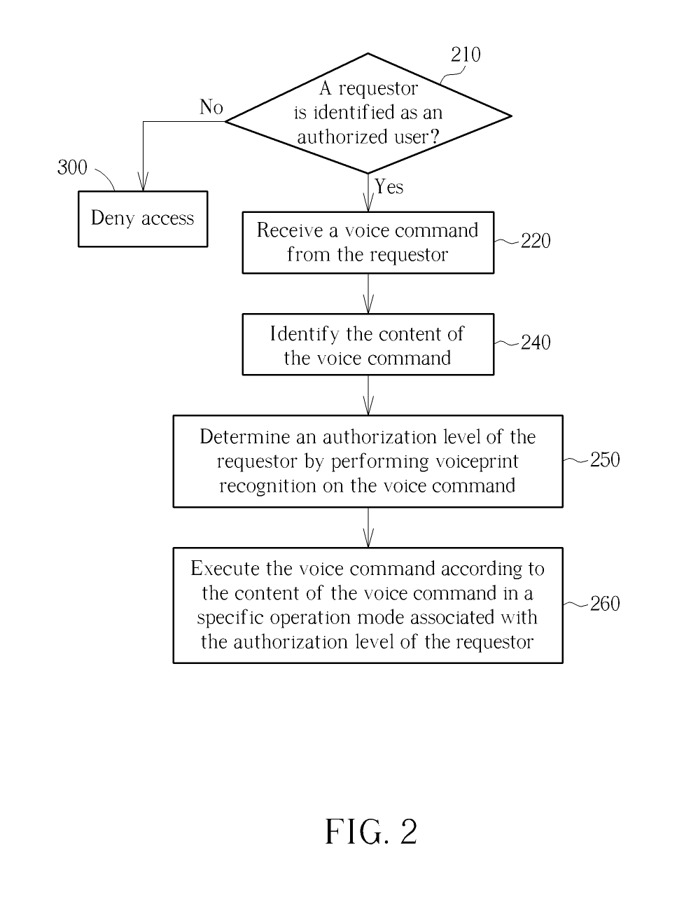

FIG. 2 is a flowchart illustrating the operation of the computer-implemented system 100 according to an embodiment of the present invention. FIG. 2 includes the following steps:

Step 210: determine whether a requestor is identified as an authorized user: if yes, execute step 220; if no, execute step 300.

Step 220: receive a voice command from the requestor, execute step 230.

Step 240: identify the content of the voice command, execute step 250.

Step 250: determine an authorization level of the requestor by performing voiceprint recognition on the voice command, execute step 260.

Step 260: execute the voice command according to the content of the voice command in a specific operation mode associated with the authorization level of the requestor.

Step 300: deny access.

In step 210, the requestor may be identified as an authorized user using any existing verification method known the art. For example, accessing the voice-controlled storage device 40 may involve application software, which may comprise a log-in procedure using a username and a password. If the requestor is an authorized user, step 220 is then executed; if the requestor is not an authorized user, step 300 is then executed for denying access. However, in another preferred embodiment of the present invention, step 210 may only include accessing the voice-controlled storage device 40 by the requestor without identifying.

In step 220, the requestor may issue a voice command to an application device. For example, the requestor may intend to create a file in a directory, read/delete a file or access a device by giving the voice command to an application device. The application device may then transmit the voice command to the voice-controlled storage device 40. As mentioned previously, the voice command may be transformed from a form of analog to digital by the application device.

In step 240, the content of the voice command may be identified by using the processing unit 44 of the voice-controlled storage device 40. In the embodiment of the present invention, one or more speech recognition or voiceprint analysis related software known in the art may be installed in the application memory 424. In this step, both the voiceprint information and the content of the voice command may be identified and recognized. The content of the voice command is recognized to control the voice-controlled storage device 40, which may include, but not limit to “open file”, “copy file” and “delete file” etc.

In step 250, the processing unit 44 may perform voiceprint recognition for determining the authorization level of the requestor who does not possessed or has not presented the credential to access the full-function mode. For example, the processing unit 44 may compare the voice command with the voice recognition database 422.

In an embodiment, if the recognized voiceprint of the voice command matches a pre-recorded privileged/administrator voiceprint in the voice recognition database 422, the authorization level of the requestor may be identified as “privileged” or “administrator”. If the voiceprint of the voice command does not match the pre-recorded privileged/administrator voiceprint in the voice recognition database 422, the authorization level of the requestor may be identified as “unprivileged”.

In another embodiment, if the recognized voiceprint of the voice command does not match the pre-recorded privileged/administrator voiceprint but matches another pre-recorded voiceprint in the voice recognition database 422, the authorization level of the requestor may be identified as “regular”. If the voiceprint of the voice command does not match all the pre-recorded voiceprints in the voice recognition database 422, the authorization level of the requestor may be identified as “normal”.

In step 260, the voice command may be executed according to the identified content in a specific operation mode associated with the authorization level.

If three different requestors issue the same voice command “log in” to the application devices UE1˜UE3 simultaneously or separately, assume that the voice-controlled storage device 40 determines that only the requestor of the application device UE1 is a privileged user. Under such circumstances, step 260 may be executed for allowing the requestor of the application device UE1 to operate in the full-functional mode and the requestors of the application devices UE2-UE3 to operate in various partial-functional modes. Therefore, in this preferred embodiment of the present invention, the voice-controlled storage device 40 may respond differently to the same voice command received from different application devices according to different authorization levels.

In the full-functional mode, the control module 46 may grant full data access to the storage system 42. For example, the requestor of the application device UE1 may access all public, sharable or private folders.

In various partial-functional modes, the control module 46 may grant limited data access to the storage system 42 according to different authorization levels. In one embodiment, if the requestors of the application devices UE2-UE3 are both unprivileged users, the voice-controlled storage device 40 may operate in a client mode in which both requestors are allowed to access all public folders and respective private folders. In another embodiment, if the requestors of the application devices UE2-UE3 are both unprivileged users and the former possesses a higher authorization level, the voice-controlled storage device 40 may operate in a first client mode in which the requestor of the application device UE2 is allowed to access all public folders, some sharable folders and respective private folders, and in a second client mode in which the requestor of the application device UE3 is allowed to access all public folders, and respective private folders.

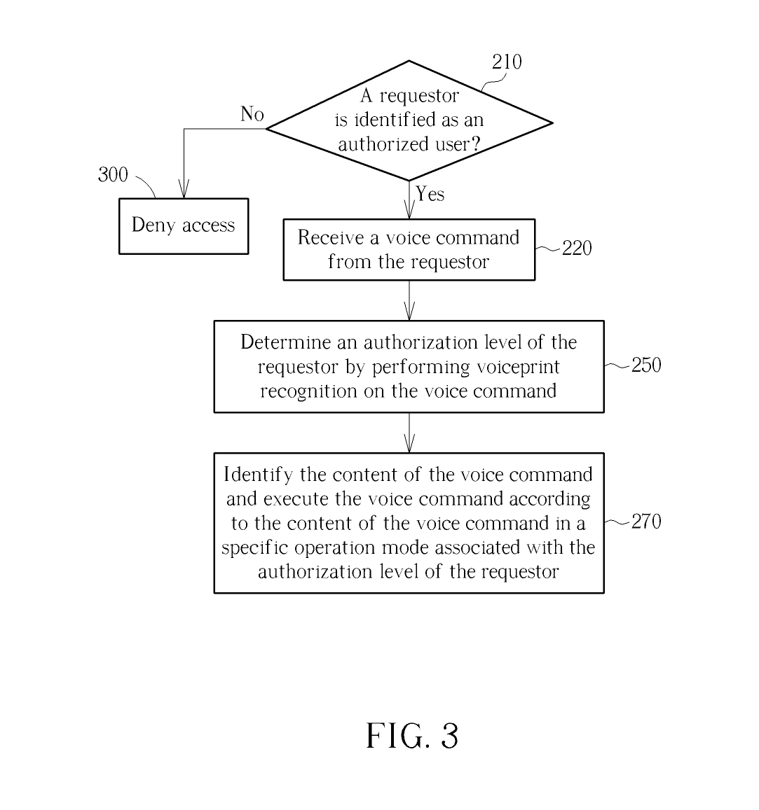

FIG. 3 is a flowchart illustrating the operation of the computer-implemented system 100 according to another embodiment of the present invention. FIG. 3 includes the following steps:

Step 210: determine whether a requestor is identified as an authorized user: if yes, execute step 220; if no, execute step 300.

Step 220: receive a voice command from the requestor, execute step 250.

Step 250: determine an authorization level of the requestor by performing voiceprint recognition on the voice command, execute step 280.

Step 270: identify the content of the voice command and execute the voice command according to the content of the voice command in a specific operation mode associated with the authorization level of the requestor.

Step 300: deny access.

In the embodiment illustrated in FIG. 3, steps 210, 220 and 250 are executed in similar manner as illustrated in FIG. 2. However, voiceprint recognition is performed in step 250 prior to identifying the content of the voice command using the processing unit 44 in step 270.

In step 270, the content of the voice command may be identified by using the processing unit 44 of the voice-controlled storage device 40, similar to step 240 in FIG. 2. Next, the voice command may be executed according to the identified content in a specific operation mode associated with the authorization level, similar to step 260 in FIG. 2.

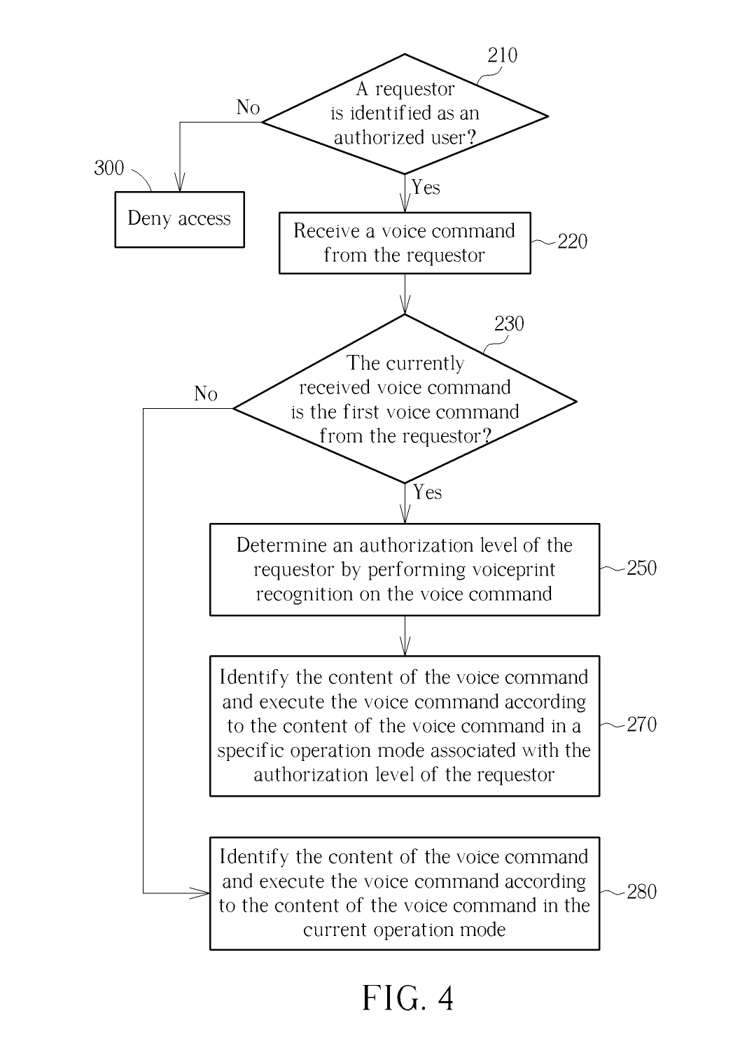

FIG. 4 is a flowchart illustrating the operation of the computer-implemented system 100 according to another embodiment of the present invention. FIG. 4 includes the following steps:

Step 210: determine whether a requestor is identified as an authorized user: if yes, execute step 220; if no, execute step 300.

Step 220: receive a voice command from the requestor, execute step 230.

Step 230: determine if the currently received voice command is the first command from the requestor: if yes, execute step 250; if no, execute step 280.

Step 250: determine an authorization level of the requestor by performing voiceprint recognition on the voice command, execute step 270.

Step 270: identify the content of the voice command execute the voice command according to the content of the voice command in a specific operation mode associated with the authorization level of the requestor.

Step 280: identify the content of the voice command execute the voice command according to the content of the voice command in the current operation mode.

Step 300: deny access.

In the embodiment illustrated in FIG. 4, steps 210, 220, 250 and 270 are executed in similar manner as illustrated in FIG. 3. However, steps 230 and 280 are further included.

In step 230, the processing unit 44 may determine whether the currently received voice command is the first command from the requestor. The “requestor” may represent any of the application devices UE1˜UEN in FIG. 1, and the first command from the requestor may refer to the first command from any of the application devices UE1˜UEN.

In step 280, the content of the voice command may be identified by using the processing unit 44 of the voice-controlled storage device 40, similar to step 240 in FIG. 2. Next, the voice command may be executed according to the identified content in the current operation mode.

Therefore, if the requestor of the application device UE1 has been verified as a privileged user by performing voiceprint recognition on a previous voice command, subsequent voice commands received from the application device UE1 may be executed in the current operation mode (full-function mode) without performing voiceprint recognition.

In the computer-implemented system 100 according to the present invention, the voice-controlled storage device 40 is configured to receive voice commands from application devices UE1˜UEN wirelessly. Therefore, the voice-controlled storage device 40 may operate in a multi-tasking mode in which multiple voice commands received from different application devices are processed simultaneously.

In the computer-implemented system 100 according to the embodiment of the present invention, multiple voice commands may be issued to multiple application devices simultaneously or separately, or to the same application device separately. Each requestor may be allowed to operate the voice-controlled storage device 40 in a corresponding operation mode according to respective authorization level. Also, if the authorization procedure in step 210 has been compromised, step 250 may prevent the hacker from accessing protected data in the voice-controlled storage device 40, such as sharable folders or private folders. Therefore, the present invention can provide a method and a computer-implemented system capable of providing efficient data management and data protection between individual application devices and the cloud-based wireless storage device

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer-implemented system for data management and protection, comprising:
an application software installed in a first application device for receiving and transmitting a first voice command; and
a storage device configured to receive the first voice command from the first application device via a network, the storage device comprising:
a storage system having a voice recognition database for storing pre-recorded voiceprints and corresponding authorization levels to operate the storage device;
a processing unit configured to identify the first voice command and compare the first voice command with the pre-recorded voiceprints in the voice recognition database; and
a control module configured to execute the first voice command according to a comparison result of the processing unit.

2. The computer-implemented system of claim 1, wherein the storage device further comprises:
an application memory having software or firmware application stored therein to be executed by the processing unit for identifying the first voice command.

3. The computer-implemented system of claim 1, wherein the first voice command identified by the processing unit comprises a voice content and a voiceprint.

4. The computer-implemented system of claim 1, wherein the first application device further comprises an analog-to-digital converter to transform a format of the first voice command from an analog signal into a digital signal.

5. The computer-implemented system of claim 1 further comprising:
a second application device for receiving and transmitting a second voice command to the storage device, and the processing unit is further configured to process the first voice command and the second voice command simultaneously.

6. A voice control method for a storage device, comprising:
transmitting a first voice command from an application device to the storage device via a network;
identifying a content and a voiceprint of the first voice command;
comparing the voiceprint with at least one pre-recorded voiceprint stored in the storage device for determining an authorization level; and
executing the first voice command according to the content of the voice command in a specific operation mode associated with the authorization level.

7. The voice control method of claim 6, further comprising:
transforming a format of the first voice command from an analog signal into a digital signal after receiving the first voice command from the application device.

8. The voice control method of claim 6, before the step of receiving the first voice command from the application device further comprising:
storing the at least one pre-recorded voiceprint in the storage device; and
defining the authorization level of the at least one pre-recorded voiceprint and the specific operation mode associated with the authorization level.

9. The voice control method of claim 6, wherein identifying the content and the voiceprint of the first voice command is performed by software or firmware application stored in the storage device.

10. The voice control method of claim 6, further comprising:
transmitting a second voice command from a second application device to the storage device through the wireless path;
identifying the second voice command;
determining a second authorization level; and
executing the second voice command according to the second authorization level.

11. The voice control method of claim 10, wherein the first voice command and the second voice command are processed by the storage device simultaneously.

12. A voice control method for a storage device, comprising:
transmitting a voice command from an application device to the storage device through a wireless path;
determining if the voice command is firstly received from the application device;
identifying a content and a voiceprint of the voice command when the voice command is firstly received from the application device;
comparing the voiceprint with at least one pre-recorded voiceprint stored in the storage device for determining an authorization level; and
executing the voice command according to the content of the voice command in a specific operation mode associated with the authorization level.

13. The voice control method of claim 12, further comprising:
identifying the content of the voice command after determining that the voice command is not firstly received from the application device; and
executing the voice command according to the content of the voice command in a current operation mode.

14. The voice control method of claim 13, wherein identifying the content of the voice command is performed by software or firmware application stored in the storage device.

15. The voice control method of claim 12, wherein identifying the content and the voiceprint of the voice command is performed by software or firmware application stored in the storage device.

16. The voice control method of claim 12, before receiving the voice command by an application device further comprising:
storing the at least one pre-recorded voiceprint in the storage device; and
defining the authorization level of the at least one pre-recorded voiceprint and the specific operation mode associated with the authorization level.

17. The voice control method of claim 12, further comprising:
transforming a format of the voice command from an analog signal into a digital signal after receiving the voice command from the application device.
